(19) United States
(12) Patent Application Publication
(10) Pub. No.: US 2002/0188684 A1
(43) Pub. Date: Dec. 12, 2002

(54) Internet telephony directly initiated from electronic mails

(76) Inventor: Robson Liang, Hong Kong (CN)

Correspondence Address: RADER FISHMAN & GRAUER PLLC, LION BUILDING, 1233 20TH STREET N.W., SUITE 501, WASHINGTON, DC, 20036, US

(21) Appl. No.: 09/875,023

(22) Filed: Jun. 7, 2001

(51) Int. Cl. G06F 15/16

(52) U.S. Cl. 709/206; 709/203; 709/217

(57) ABSTRACT

A system and method which integrate e-mail and Internet telephony services into one solution. Are disclosed. Advantageously, an e-mail recipient may initiate a call to the mail sender by clicking on the hyperlinks attached on the e-mail. In brief, the present invention provides an improved IP telephony service which is more user friendly, convenient and efficient as compared to conventional IP telephony services.

### FIELD OF THE INVENTION

The present invention relates to a system for initiating voice transmission using e-mail to traditional telecommunication network via the Internet. More specifically, it relates to a system that integrates Voice over Internet Protocol (“VoIP”) technologies into HyperText Markup Language (“HTML”) coded e-mail.

### BACKGROUND OF THE INVENTION

With fast advancement of the Internet, electronic mail (“e-mail”) has become an important communication choice for an ever-increasing number of individuals who have turned to it as an inexpensive and effective way of exchanging electronic data and information.

While often thought of as a world-wide network, in reality the Internet is comprised of numerous different networks throughout the world which are linked together using a common routing protocol known as the Internet protocol (“IP”). This architecture provides Internet users with widespread access from an unspecified number of terminals or other dial-up equipments around the world.

Individual users, groups and other entities are identified on the Internet by a unique address conforming to the IP. A local access hub provides users with an entrance to get into the Internet network and acts as the exchange point for both incoming and outgoing data. The data flows along virtual channels consisting of a plurality of gateways, data routers and other physical equipments which work together to form a signal path from message origin to its intended destination. Since a point-to-point connection is never established, the costs to the user are limited to those charged by the local access provider and/or a nominal periodic access fee.

The low cost associated with high speed Internet access and the ever-surging demand of the information technology (“IT”) community have speeded up the development of voice communication applications over Internet protocol that allows users to receive and transmit compressed Internet voice messages across the Internet rather than through the conventional Public Switched Telephone Network (“PSTN”).

Typically, a user at one end of the connection speaks into a microphone attached to a personal computer (“PC”). The microphone carries the audio voice signal to a processor board in the PC which digitizes the signal and creates a digital voice file. The voice file is then typically compressed and transferred to a selected recipient at a distant point on the Internet. Once received, the voice file is decompressed and converted via digital signal processing to an audible signal intelligible to the human ear.

A typical Internet audio set includes a PC, modem, Internet access software, file compression software and operating system. The user executes the software off the PC's hard disk or floppy drive and the modem provides the hardware communications link with the local Internet access provider. This operation involves turning on the PC, executing the software, gaining access to the Internet, recording the voice file and transmitting to its intended recipient. At the receiving end, the process is duplicated in almost exact fashion but in reverse.

Such VoIP applications are available and useful for effecting inexpensive long distance voice communications. They are especially suitable for those who have high demand for long distance calls and those who find the traditional long distance call charges prohibitively expensive.

While VoIP solutions are gaining popularity and e-mail usages on the rise, there is no system which integrates these two applications into one.

In light of the increasing needs of the IT community for services which converge voice and e-mail, the present invention provides a total solution which integrates VoIP solutions with HTML coded e-mails.

Furthermore, the current existing PC-to-phone or PC-to-PC services require the users to logon the website and key-in the hassle telephone string (telephone numbers of the call-receiver) to place calls. In contrast, the present invention allows e-mail recipients to place a call to the mail sender by simply clicking on the HTML coded icon attached at the end of the e-mail from a mail senders. In addition to enjoying the advantages of convenience and user-friendliness of such service, the mail sender can keep his/her telephone number undisclosed.

In brief, the present invention provides an improved IP telephony service which is more user friendly, convenient and efficient as compared to conventional IP telephony services.

### SUMMARY OF THE INVENTION

An object of the present invention is to integrate the VoIP technology with e-mails, whereby it allows recipients of an e-mails to initiate IP telephony communication with the e-mail sender by simply clicking the HTML coded icon attached to the e-mail received.

Another object of the present invention is to cut down the costs of long distance telephone calls by using the integrated VoIP and e-mail system disclosed herein.

According to one aspect of the present invention, it provides an e-mail-IP telephony system comprising an IP telephony hyperlink appended to an e-mail sent to a recipient by a subscriber of the system wherein the recipient clicks on the hyperlink to initiate a telephone call to the subscriber; a gatekeeper interfacing between a recipient's software and a subscriber information verification and authentication means, wherein the gatekeeper assesses a voice communication channel opening request from the recipient; a web phone call (“WPC”) document containing an IP address of the gatekeeper with subscription information and a designated telephone number of the subscriber; a router service management for the gatekeeper to search a specific router and to send an IP address of a specific gateway to the recipient's software; and the specific gateway in communication with the gatekeeper to release the voice communication channel to the recipient and to connect voice packets from the recipient with a PSTN of the subscriber.

According to another aspect of the present invention, it provides a method for connecting an electronic-mail (“e-mail”)-Internet Protocol (“IP”) telephone call comprising a one-time collection of information from an e-mail sender and storing the information in an e-mail-IP telephony system; the e-mail sender sending an e-mail to a recipient with an IP telephony hyperlink appending to the e-mail; the e-mail recipient clicking the IP telephony hyperlink to initiate a telephone call to the subscriber and to activate a request to open a voice communication channel; a system website in communication with the IP telephony hyperlink and sending a WPC document to the recipient; wherein the WPC document containing IP address of the gatekeeper with subscription information and a designated telephone number of the subscriber; the WPC document sending the subscriber's information to the gatekeeper, wherein the gatekeeper interfacing with a subscriber information verification and authentication means for authenticating the subscriber's information; the gatekeeper searching for specific router from a router service management and sending the IP address of a specific gateway to the recipient's software; and the gatekeeper authenticating the WPC document and notifying a gateway to release the voice communication channel to the recipient and the gateway connecting voice packets from the recipient with a PSTN of the subscriber.

### BRIEF DESCRIPTION OF THE DRAWINGS

The various features of the present invention are explained in greater detail thereafter with reference to the illustrative examples which are shown in the accompanying drawings:

FIG. 1 illustrates the operation flow in accordance with the preferred embodiment of the present invention;

FIG. 2 shows the interplay of technical flow of the system components for initiating a VoIP-e-mail call in accordance with the preferred embodiment of the present invention; and

FIG. 3 illustrates the technical flow when a VoIP-e-mail call is being initiated in accordance with the preferred embodiment of the present invention.

### DETAILED DESCRIPTION OF THE PREFERRED EMBODIMENT

The system according to the present invention is designed to integrate the VoIP technology with e-mails and, in so doing, eliminates the expenses normally associated with placing long distance phone calls.

The subscribers to this system can be anybody. Typically, the subscriber is the e-mail sender (“subscriber”). Anyone can be the e-mail recipient (“recipient”). In a business environment, the recipients are usually clients or customers of the business.

Since a e-mail sender and a recipient may be located geographically quite far from one another, toll-free callings are usually put in place by the e-mail sender to encourage and entice the recipient to contact the sender by telephone. Without subscribing to the operating system of the present invention, the sender must incur significant costs in entertaining such incoming toll-free calls. However, once the sender subscribes to the operating system of the present invention, no long distance charges will be applied.

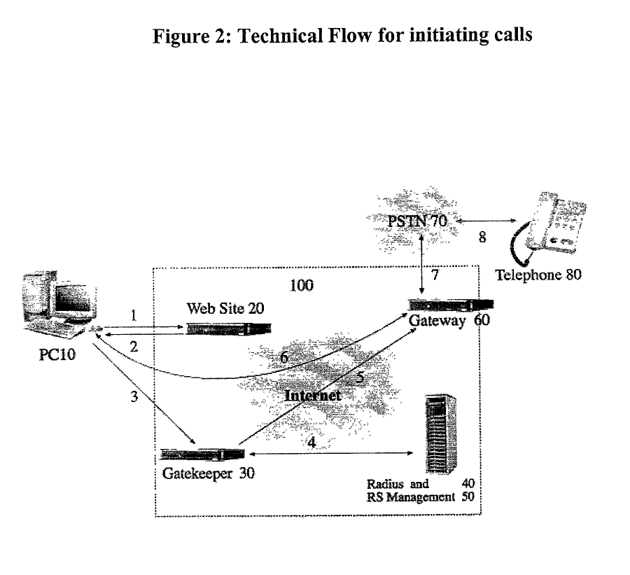

Referring to FIG. 2, operating system 100 can be set up in any geographic locality. For illustration purpose, it is assumed that operating system 100 is being set up in New York City. Subscribers of the present invention situating within the New York City limit will not incur long distance telephone charges when e-mail recipients call them through operation system 100, despite the fact that these recipients may be located in places where normal long distance charges apply.

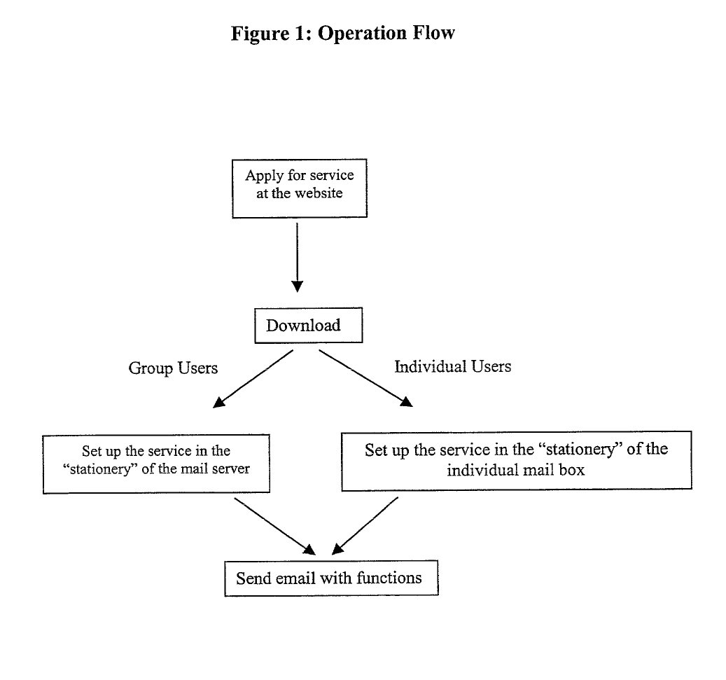

With reference to FIG. 1, a subscriber must first subscribe to the operating system of the present invention before operating system 100 (FIG. 2) can be accessed. The registration/subscription process will include collecting and assigning data for identification purpose, such as account number, password and Internet protocol telephone numbers, etc. Once registered, the subscriber downloads the system operating software which enables the subscriber to access operating system 100. As used herein the term “system operating software” is defined as including the application software code, and/or firmware required to perform specific functions used in the operation system 100 and is a matter of design choice and is considered to be well within the scope of knowledge of the person of skill in the art.

Depending on whether the subscribers are group users or individual users, the system operating software may be set up in the “stationery” of the mail server of the group users, or in the “stationery” of the mail box of the individual users. Once downloading of the system operating software is completed, the subscriber is ready to send out e-mails whereby the recipients can initiate VoIP—e-mail IP telephony with ease.

Typically, an e-mail received from a subscriber of the system takes the following format:

“Dear Recipient:

***Body of the e-mail***

Sincerely yours,

Sender

[symbol] [symbol] [symbol] 1-800-1234567

[symbol]

[symbol]

[symbol]

Please simply click this toll-free telephone icon to call me!”

Suitably, the Internet protocol HTML coded telephone icon appears as a hyperlink (typically displayed in blue colour on a computer monitor) at the end of the subscriber's e-mail.

To initiate the IP telephony calls, the recipients are required to have multimedia PC with standard microphone and headset.

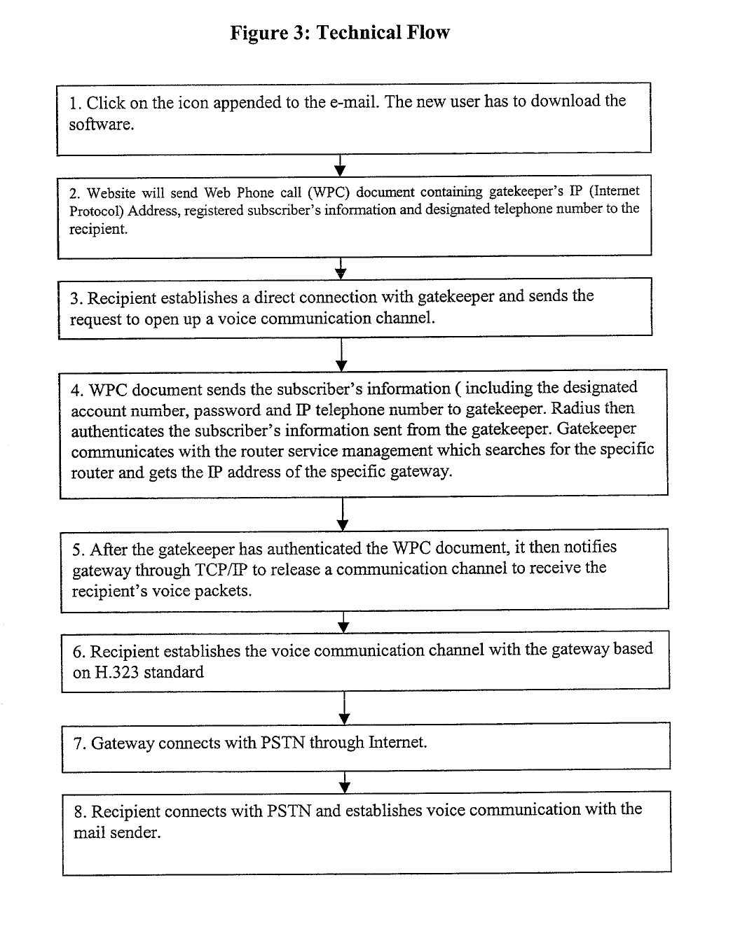

The system operation is now explained in further details with reference to FIGS. 2 and 3:

Step 1

When a recipient clicks on the HTML coded telephone icon from her/his PC 10, she/he will be linked to system website 20 of the operating system 100.

Step 2

The system employs the web phone call (“WPC”) document (not shown) facility to assign a unique IP telephone number to the individual subscribers.

After the recipient is linked to the system website 20, the latter sends out a WPC document containing gatekeeper's 30 IP address, registered subscriber's information and designated telephone number to the recipient. In the present invention, each WPC document has a specific IP telephony number which correlates with the individual subscribers.

It is to be noted that WPC is of a document type. After installing the mini webphone software, the web browser will regard all the http ended with .wpc as a signal for initiating Internet phone calls. The web browser will load the mini webphone program automatically and place PC-to-phone calls according to the parameters in the WPC document. Mini webphone can establish calls either through connecting directly to non-authenticated gateway or pass through gatekeeper for authentication before connecting to gateway. A WPC document corresponds with a particular telephone. Different telephones correspond with different WPC documents.

Step 3

At this stage, the recipient establishes a direct connection with gatekeeper 30 and relays a request to open up a channel for voice communication.

Step 4

The WPC document forwards the Subscriber's information, which includes the designated account number, password and IP telephone number to gatekeeper 30. The Remote Authentication Dial in User Service (“Radius”) 40 (which is an authentication and accounting system for authenticating and controlling access rights of a large amount of users from distributed databases) to undergo authentication of the IP telephone number, account number, password, account balance and status of subscriber.

It is to be noted that operating system use Structured Query Language (“SQL”) server as the database management system (“DBMS”). SQL is a standardized query language for requesting information from a database. SQL is being supported by PC database systems because it supports distributed databases (databases that are spread out over several computer systems). This enables several users on a local-area network to access the same database simultaneously.

Gatekeeper 30 searches for the specific router in the router service management 50 and sends the IP address of the specific gateway to WPC.

Step 5

After gatekeeper 30 has authenticated the WPC document, it then notifies gateway 60 through TCP/IP to release a communication channel to receive the recipient's voice packets.

As used herein, the term Transport Control Protocol/Internet Protocol (“TCP/IP”) generally refers to the communication suites used to connect hosts on the Internet.

Step 6

Recipient establishes the voice communication channel with gateway 60 based on H.323 Standard.

The reference H.323 used herein is a standard approved by the International Telecommunication Union (ITU) that defines how audio and audiovisual conferencing data is transmitted across networks.

Step 7

Gateway 60 connects with the PSTN 70 situated within city limit of the subscriber's locality.

Step 8

Recipient connects with PSTN 70 and establishes the voice communication with the mail sender—subscriber who speaks into telephone 80 and treats the call from the recipient as a local phone call, thus averting long distance costs.

At this step, gateway 60 connects with PSTN 70 through the Internet. The voice packets of the operating system 100 is being sent out in User Datagram Protocol (“UDP”) format and is being received by gateway 60. The voice packets are then converted to voice coded format used in PSTN 70 and then sent to the mail sender—subscriber in the format of Associated Signalling or Common channel signalling.

As used herein, signalling is for controlling the establishment of the voice communication process in PSTN. It can be classified into 2 main categories according to the channel of signalling, namely Associated Signalling and Common channel signalling. With associated Signalling, signalling and voice are transmitted on the same telephone channel. With common channel signalling, a series of communication signals are transmitted on an information link at a very high speed.

By subscribing to the operating system of the present invention, e-mail senders can effectively encourage recipients to place toll-free IP telephony calls without the trouble of having to enter a long string of telephone numbers. While such calls may be initiated from e-mail recipients where normally long distance charges apply, the operating system of the present invention favourably averts the need to incur these charges as it treats the incoming calls as local phone calls.

Thus, while there have been shown and described and pointed out fundamental novel features of the invention as applied to preferred embodiments thereof, it will be understood that various omissions and substitutions and changes in the form and details of the system illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

What is claimed is:

1.An electronic-mail (“e-mail”)-Internet Protocol (“IP”) telephony system comprising:
an IP telephony hyperlink appended to an e-mail sent to a recipient by a subscriber of the system wherein the recipient clicks on the hyperlink to initiate a telephone call to the subscriber;
a gatekeeper interfacing between said recipient's software and a subscriber information verification and authentication means, wherein said gatekeeper assesses a voice communication channel opening request from the recipient;
a web phone call (“WPC”) document containing an IP address of said gatekeeper with subscription information and a designated telephone number of said subscriber;
a router service management for said gatekeeper to search a specific router and to send an IP address of a specific gateway to the recipient's software; and
said specific gateway in communication with the gatekeeper to release the voice communication channel to the recipient and to connect voice packets from said recipient with a PSTN of said subscriber.

2. An e-mail-IP telephony system as in claim 1, wherein said recipient's software is a mini webphone.

3. An e-mail-IP telephony system as in claim 1, wherein the subscriber information verification and authentication means is Remote Authentication Dial in User Service (“Radius”).

4. An e-mail-IP telephony system as in claim 1, wherein said specific gateway communicates with said gatekeeper through Transport Control Protocol/Internet Protocol (“TCP/IP”) communication suite.

5. An e-mail-IP telephony system as in claim 1, wherein said PSTN is housed at the subscriber's locality to avert the subscriber from incurring long distance telephone charges.

6. An e-mail-IP telephony system as in claim 1, wherein said IP telephony hyperlink appended on said e-mail appears as a toll-free telephone number.

7. An e-mail-IP telephony system as in claim 5, wherein said toll-free telephone number is a 1-800 number.

8. A method for connecting an electronic-mail (“e-mail”)-Internet Protocol (“IP”) telephone call comprising:
a one-time collection of information from an e-mail sender and storing said information in an e-mail-IP telephony system;
said e-mail sender sending an e-mail to a recipient with an IP telephony hyperlink appending to said e-mail;
said e-mail recipient clicking said IP telephony hyperlink to initiate a telephone call to the subscriber and to activate a request to open a voice communication channel;
a system website in communication with said IP telephony hyperlink and sending a web phone call (“WPC”) document to the recipient; wherein said WPC document containing IP address of said gatekeeper with subscription information and a designated telephone number of said subscriber;
said WPC document sending the subscriber's information to said gatekeeper, wherein said gatekeeper interfacing with a subscriber information verification and authentication means for authenticating the subscriber's information;
said gatekeeper searching for specific router from a router service management and sending the IP address of a specific gateway to said recipient's software; and
said gatekeeper authenticating the WPC document and notifying a gateway to release the voice communication channel to the recipient and said gateway connecting voice packets from said recipient with a PSTN of said subscriber.

9. A method for connecting an e-mail-IP telephone call as in claim 7, wherein the subscriber information verification and authentication means is Remote Authentication Dial in User Service (“Radius”).

10. A method for connecting an e-mail-IP telephone call as in claim 7, wherein said specific gateway communicates with said gatekeeper through Transport Control Protocol/Internet Protocol (“TCP/IP”) communication suite.

11. A method for connecting an e-mail-IP telephone call as in claim 7, wherein said PSTN is housed at the subscriber's locality to avert the subscriber from incurring long distance telephone charges.

12. A method for connecting an e-mail-IP telephone call as in claim 7, wherein said IP telephony hyperlink appended on said e-mail appears as a toll-free telephone number.

13. A method for connecting an e-mail-IP telephone call as in claim 11, wherein said toll-free telephone number is a 1-800 number.
